(19) United States
(12) Patent Application Publication
(10) Pub. No.: US 2002/0089271 A1
(43) Pub. Date: Jul. 11, 2002

(54) Cabinet door system

(76) Inventor: John C. Turner, Cedar Falls, IA (US)

Correspondence Address: Michael S. Neustel, 2534 South University Drive, Suite No. 4, Fargo, ND, 58103, US

(21) Appl. No.: 09/875,471

(22) Filed: Jun. 5, 2001

Related U.S. Application Data
(63) Continuation of application No. 09/715,617, filed on Nov. 20, 2000.

(51) Int. Cl. E06B 1/00

(52) U.S. Cl. 312/321.5

(57) ABSTRACT

A cabinet door system for allowing easy changing of the inner panels of cabinet doors without requiring the usage of tools or a skilled carpenter. The cabinet door system includes a cabinet door having an outer frame and a center opening with an inner rabbet, a retaining structure pivotally attached to the outer frame and positionable within the inner rabbet, an inner panel removably positionable within the retaining structure, and a pair of latches attached to the outer frame for removably securing the retaining structure within the inner rabbet of the outer frame. The latches each include a shaft slidably positioned within that extend to engage an opening within a corresponding pair of catch members that are attached to the retaining structure.

### CROSS-REFERENCE TO RELATED U.S. PATENT APPLICATION

I hereby claim benefit under Title 35, United States Code, Section 120 of U.S. patent application Ser. No. 09/715,617 filed Nov. 20, 2000. This application is a continuation-in-part of the Ser. No. 9/715,617 application. The Ser. No. 09/715,617 application is currently pending. The Ser. No. 09/715,617 application is hereby incorporated by reference into this application.

### BACKGROUND OF THE INVENTION

1. Field of the Invention

The present invention relates generally to cabinet doors and more specifically it relates to a cabinet door system for allowing easy changing of the inner panels of cabinet doors without requiring the usage of tools or a skilled carpenter.

2. Description of the Prior Art

Cabinet doors have been in use for years. Typically, a cabinet door is comprised of an outer frame having a rectangular shape with an inner panel permanently secured within the outer frame.

The main problem with conventional cabinet doors is that they do not allow for the consumer to easily change the appearance of their cabinetry without extensive time, labor and money. In addition, conventional cabinet doors require an individual to initially match their cabinetry with wallpaper and paint prior to installation since changing conventional cabinetry is typically not feasible.

Examples of patented cabinet related devices which are illustrative of such prior art include U.S. Pat. No. 1,651,941 to Ashkenas; U.S. Pat. No. 729,148 to Fabry; U.S. Pat. No. 5,806,942 to Jenkins, Jr. et al.; U.S. Pat. No. 5,546,714 to Kenkel; U.S. Pat. No. 4,229,921 to Schell.

While these devices may be suitable for the particular purpose to which they address, they are not as suitable for allowing easy changing of the inner panels of cabinet doors without requiring the usage of tools or a skilled carpenter. Conventional cabinets do not allow for the interchanging of the inner panels and appearance.

In these respects, the cabinet door system according to the present invention substantially departs from the conventional concepts and designs of the prior art, and in so doing provides an apparatus primarily developed for the purpose of allowing easy changing of the inner panels of cabinet doors without requiring the usage of tools or a skilled carpenter.

### SUMMARY OF THE INVENTION

In view of the foregoing disadvantages inherent in the known types of cabinet devices now present in the prior art, the present invention provides a new cabinet door system construction wherein the same can be utilized for allowing easy changing of the inner panels of cabinet doors without requiring the usage of tools or a skilled carpenter.

The general purpose of the present invention, which will be described subsequently in greater detail, is to provide a new cabinet door system that has many of the advantages of the cabinet devices mentioned heretofore and many novel features that result in a new cabinet door system which is not anticipated, rendered obvious, suggested, or even implied by any of the prior art cabinet devices, either alone or in any combination thereof.

To attain this, the present invention generally comprises a cabinet door having an outer frame and a center opening with an inner rabbet, a retaining structure pivotally attached to the outer frame and positionable within the inner rabbet, an inner panel removably positionable within the retaining structure, and a pair of latches attached to the outer frame for removably securing the retaining structure within the inner rabbet of the outer frame. The latches each include a shaft slidably positioned within that extend to engage an opening within a corresponding pair of catch members that are attached to the retaining structure.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a cabinet door system that will overcome the shortcomings of the prior art devices.

A second object is to provide a cabinet door system for allowing easy changing of the inner panels of cabinet doors without requiring the usage of tools or a skilled carpenter.

A further object is to provide a cabinet door system that is easy to utilize without requiring significant physical exertion to remove and insert inner panels.

Another object is to provide a cabinet door system that does not require the entire replacement of cabinetry to change the appearance of existing cabinetry.

An additional object is to provide a cabinet door system that is of a simple constructed.

A further object is to provide a cabinet door system that is easy and simple to utilize.

Another object is to provide a cabinet door system that is capable of being utilized upon various types of cabinets such as but not limited to ground level and elevated cabinets.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with the inner panel partially removed.

FIG. 3 is an exploded view of the latch and catch member.

FIG. 4 is a side cutaway view of the latch illustrating the shaft slidably positioned within and fully extended.

FIG. 5 is a side cutaway view of the latch illustrating the shaft slidably positioned within and fully contracted.

FIG. 6 is an upper perspective view of an alternative embodiment of the latch illustrating the leverage member.

FIG. 7 is a top view of the alternative embodiment latch with the leverage member traverse to the shaft fully extended.

FIG. 8 is a top view of the alternative embodiment latch with the leverage member parallel to the shaft fully contracted.

### DESCRIPTION OF THE PREFERRED EMBODIMENT

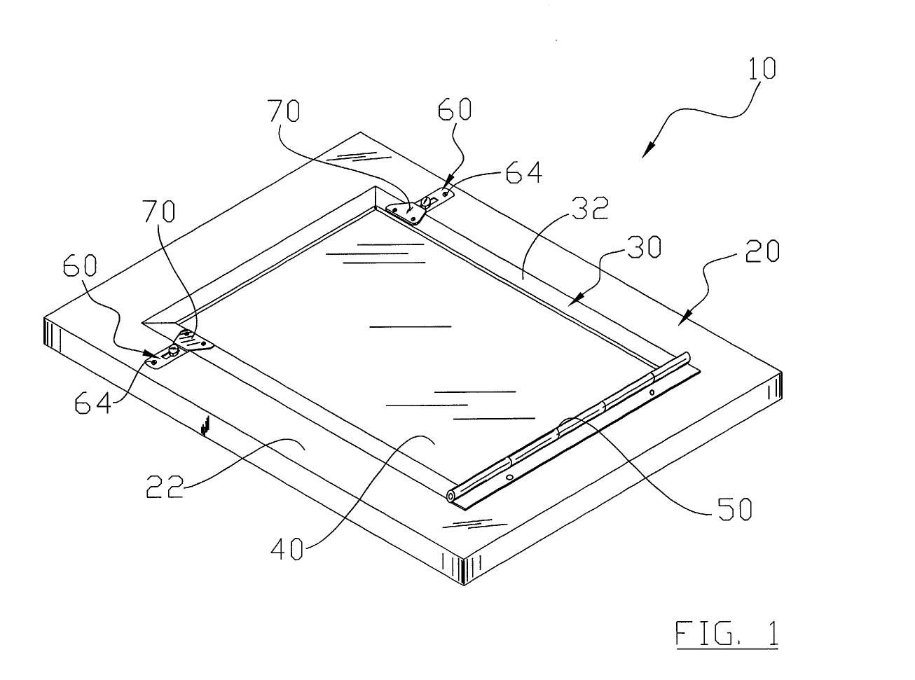

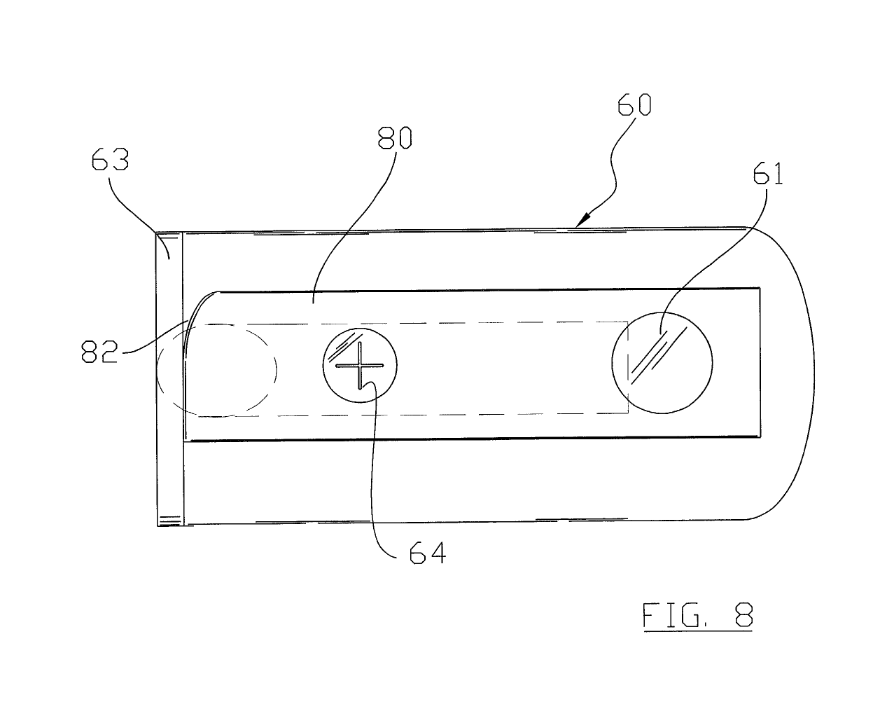

Turning now descriptively to the drawings, in which similar reference characters denote similar elements throughout the several views, FIGS. 1 through 8 illustrate a cabinet door system 10, which comprises a cabinet door 20 having an outer frame 22 and a center opening 26 with an inner rabbet 24, a retaining structure 30 pivotally attached to the outer frame 22 and positionable within the inner rabbet 24, an inner panel 40 removably positionable within the retaining structure 30, and a pair of latches 60 attached to the outer frame 22 for removably securing the retaining structure 30 within the inner rabbet 24 of the outer frame 22. The latches 60 each include a shaft 68 slidably positioned within that extend to engage an opening 72 within a corresponding pair of catch members 70 that are attached to the retaining structure 30.

Conventional cabinetry includes a housing structure with at least one cabinet door 20 pivotally attached to the structure. The cabinet door 20 is typically rectangular shaped however it may be comprised of various shapes as can be appreciated by one skilled in the art. The cabinet door 20 may also be comprised of various types of materials such as but not limited to wood, plastic and metal.

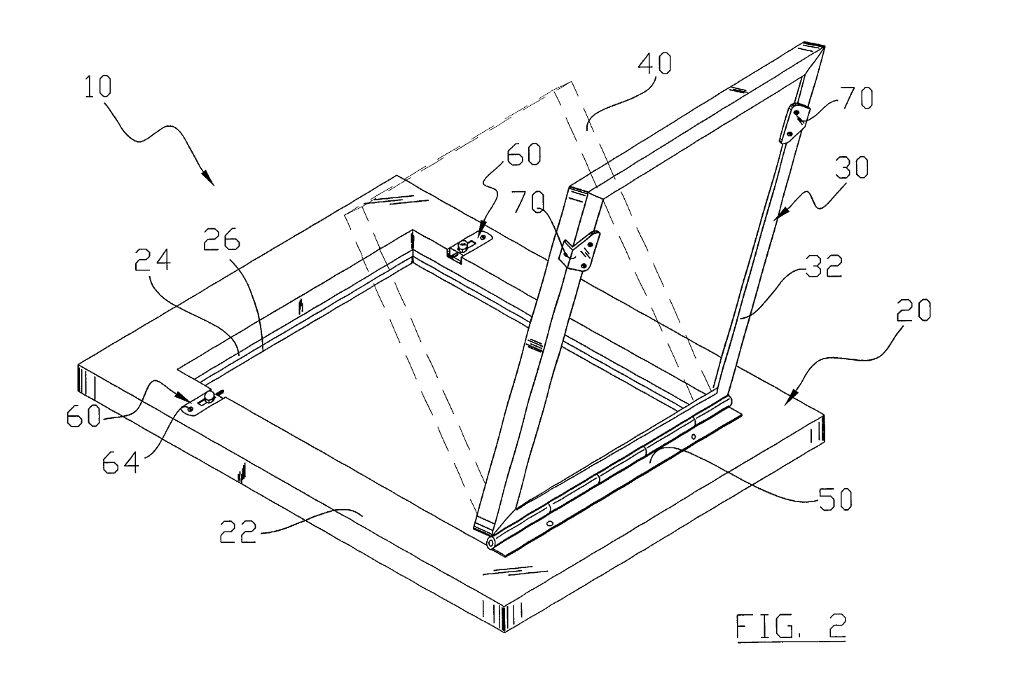

As shown in FIGS. 1 and 2 of the drawings, the cabinet door 20 is comprised of an outer frame 22 and an inner panel 40. The outer frame 22 has a front surface and a rear surface. The outer frame 22 may also include various designs, colors and indicia upon the outer surface thereof as desired.

The outer frame 22 has a center opening 26 as best shown in FIGS. 1 and 2 of the drawings. The center opening 26 may be comprised of any well-known shape, however the center is preferably comprised of a rectangular structure to reflect traditional cabinetry designs. An inner rabbet 24 extends into the rear surface of the outer frame 22 surrounding the center opening 26 for receiving the retaining structure 30 as shown in FIG. 2.

As shown in FIGS. 1 and 2 of the drawings, the retaining structure 30 is shaped to fit within the inner rabbet 24 of the outer frame 22. The lower edge of the retaining structure 30 is pivotally attached to the outer frame 22 with a hinge 50 as shown in FIGS. 1 and 2 of the drawings. The retaining structure 30 has an inner lip 32 that extends inwardly to assist in retaining the inner panel 40 within the inner rabbet 24 of the outer frame 22 of the cabinet door 20. The retainer structure has an L-shaped cross sectional area.

A length of engaging strip may be secured to an inner surface of the inner lip 32 for engaging the inner panel 40. The engaging strip may be comprised of various types of absorbing material such as but not limited to foam, rubber or pile.

As shown in FIGS. 1 and 2 of the drawings, the inner panel 40 is a generally flat and broad structure formed to fit upon the inner lip 32 of the retaining structure 30. The inner panel 40 may be comprised of various types of materials such as but not limited to wood, metal and plastic. The inner panel 40 may also include various designs, colors and indicia upon the outer surface thereof as desired.

As shown in FIGS. 1 and 2 of the drawings, a pair of latches 60 are attached to the outer frame 22 of the cabinet door 20 adjacent the side portions of the retaining structure 30. The latches 60 are formed for allowing selecting engaging of the retaining structure 30 for securing the retaining structure 30 within the inner rabbet 24 of the outer frame 22. The latches 60 are preferably positioned within a corresponding pair of cutouts within the outer frame 22 so as to be positioned relatively flush with the surface of the cabinet door 20.

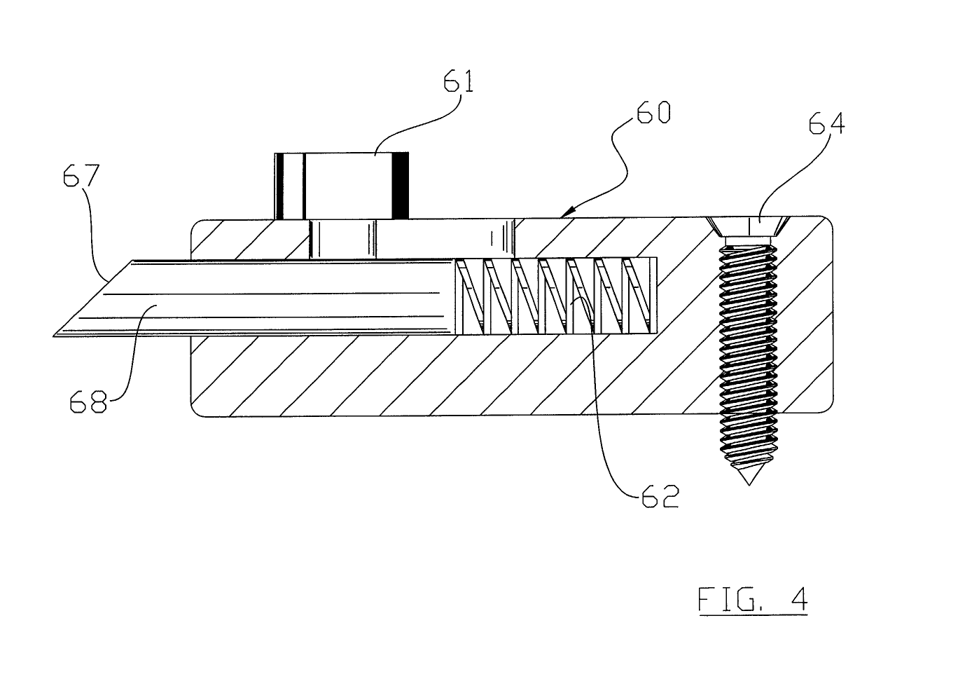

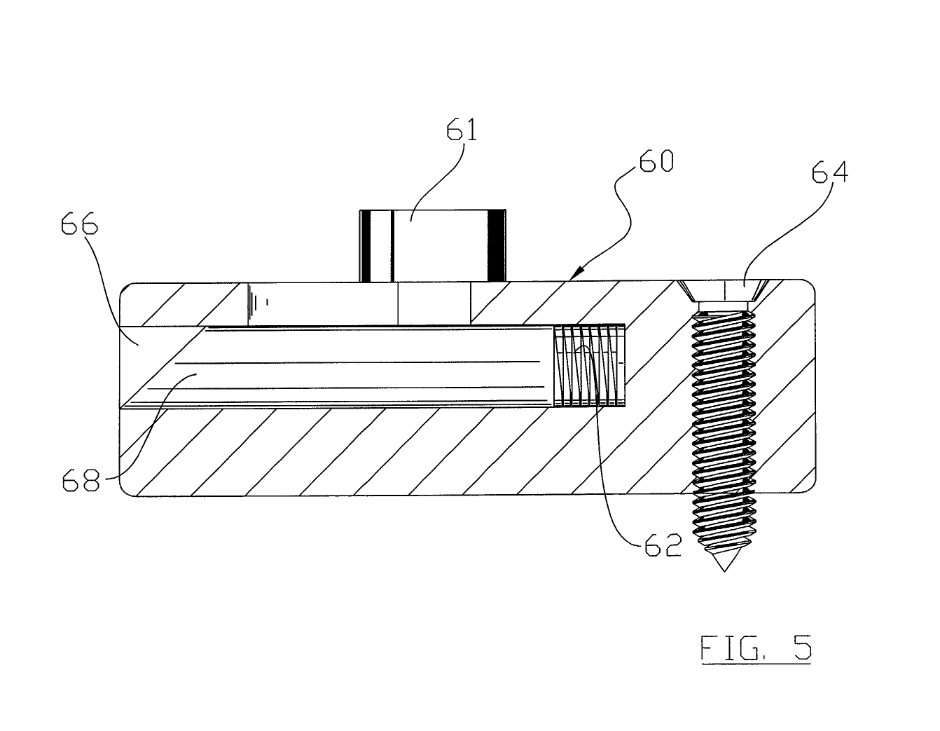

The latches 60 have an elongate body with a slot 66 extending longitudinally within as shown in FIG. 5 of the drawings. A shaft 68 slidably extends within the slot 66 as further shown in FIGS. 4 and 5 of the drawings. A compression spring 62 is positioned within the slot 66 behind the shaft 68 for extending the shaft 68 outwardly 5 from within. The distal end of the shaft 68 preferably has a slanted edge 67 as best shown in FIGS. 4 and 5 of the drawings.

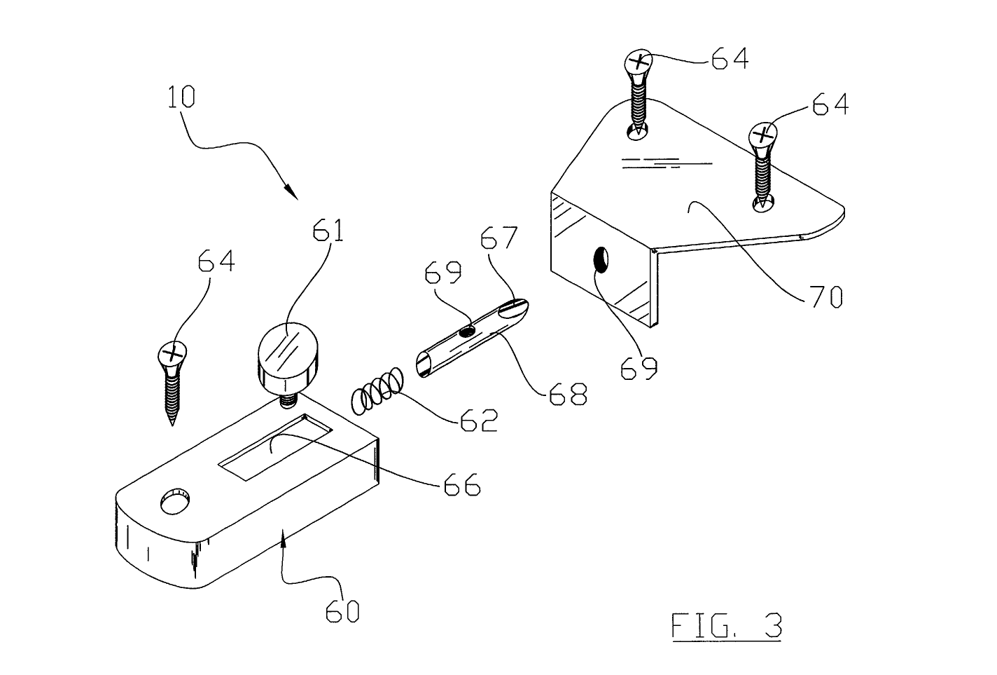

As shown in FIGS. 4 and 5 of the drawings, a handle 61 is attached to the shaft 68 for allowing the user to manually contract the shaft 68 within the latch. The handle 61 preferably is threadably engaged to the shaft 68 within an interiorly threaded aperture 69 within the shaft 68. As shown in FIGS. 3 through 5 of the drawings, at least one fastener 64 extends through the latches 60 for securing the latches 60 to the cabinet door 20 adjacent the retaining structure 30.

As shown in FIG. 3 of the drawings, a corresponding pair of catch members 70 are provided that are attached about the retaining structure 30 opposite of each of the latches 60. The catch members 70 are formed to include at least one opening 72 within for catchably receiving the shaft 68 when extended from the latch 60.

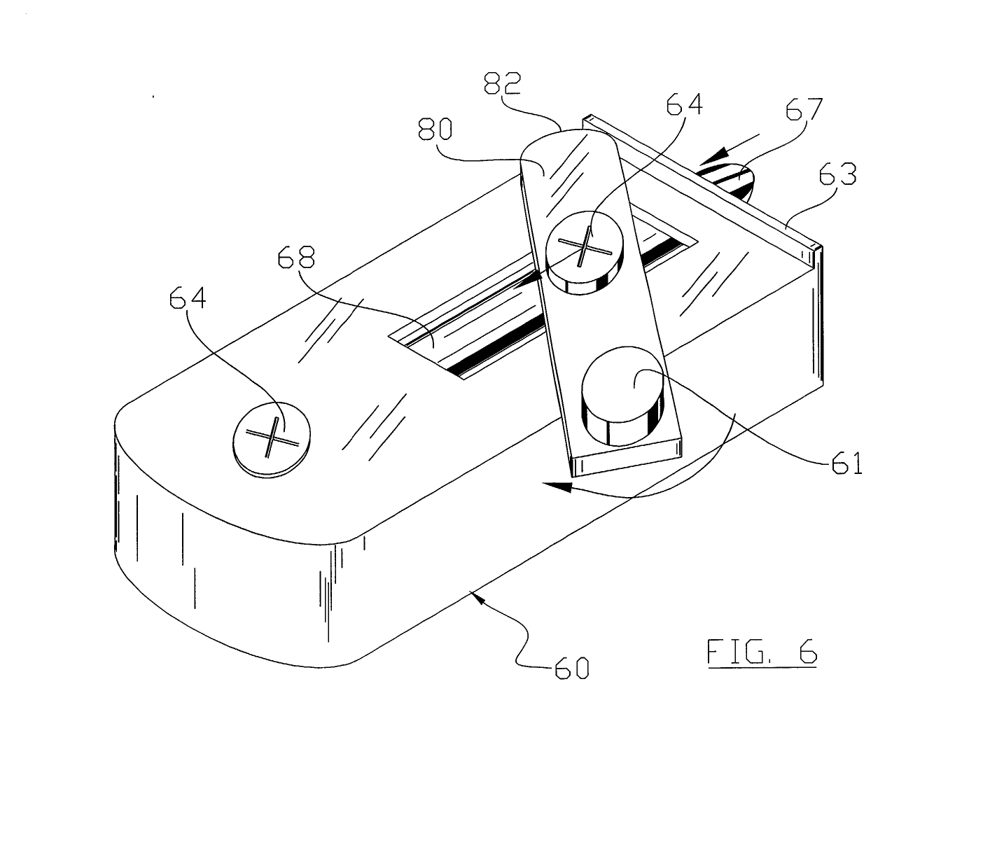

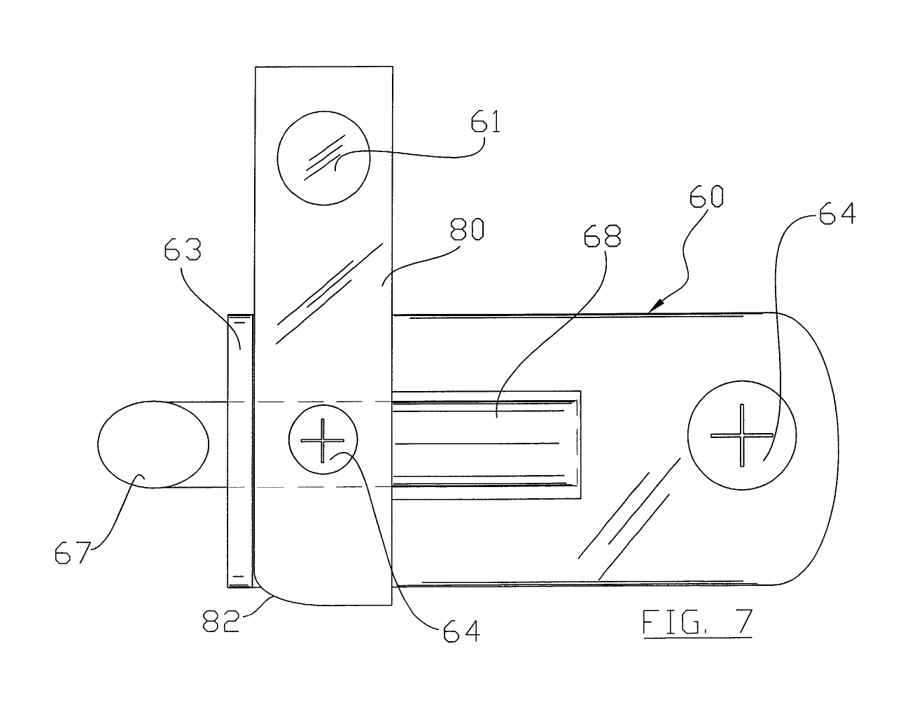

In an alternative embodiment shown in FIGS. 6 through 8 of the drawings, a leverage member 80 is attached to the shaft 68 by a fastener 64. A lip 63 extends from each of the latches 60 thereby engaging an engaging edge 82 of the leverage member 80 during rotation of the leverage member 80. A handle 61 may be attached to the leverage member 80 opposite of the engaging edge 82 as best shown in FIG. 6 of the drawings. As shown in FIG. 7 of the drawings, when the leverage member 80 is traverse to the shaft 68, the shaft 68 is allowed to be fully extended from within the latch 60. When the leverage member 80 is positioned parallel to the shaft 68 the shaft 68 is contracted inwardly within the latch 60 causing the spring 62 to become compressed. The engaging edge 82 is preferably rounded to allow for smooth movement of the leverage member 80 about the latch 60 and the lip 63.

In use, the user manipulates the shafts 68 within the latches 60 so that the extended portions of the shafts 68 do not extend into the catch members 70. The user then pivots the retaining structure 30 outwardly and removes the existing inner panel 40 as best shown in FIG. 2 of the drawings. The user then selects the inner panel 40 having the desired appearance and positions the selected inner panel 40 within the retaining structure 30. The user then closes the retaining structure 30 within the inner rabbet 24 of the outer frame 22 as shown in FIG. 1 of the drawings. During the repositioning of the retaining structure 30 into the cabinet door 20, the catch members 70 preferably slide upon the slanted edge 67 of the shaft 68 thereby manipulating the shaft 68 inwardly into the latch 60 until the opening 72 is aligned with the shaft 68 after which the shaft 68 extends into the opening 72 of the catch members 70 to catchably retain the retaining structure 30 within the cabinet door 20. If another inner panel 40 is desired, the above process is simply repeated.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

ENVIRONMENTAL ELEMENTS

10. Cabinet Door System
11.
12.
13.
14.
15.
16.
17.
18.
19.
20. Cabinet Door
21.
22. Outer Frame
23.
24. Inner Rabbet
25.
26. Center Opening
27.
28.
29.
30. Retaining Structure
31.
32. Inner Lip
33.
34.
35.
36.
37.
38.
39.
40. Inner Panel
41.
42.
43.
44.
45.
46.
47.
48.
49.
50. Hinge
51.
52.
53.
54.
55.
56.
57.
58.
59.
60. Latches
61. Handle
62. Spring
63. Lip
64. Fastener
65.
66. Slot
67. Slanted Edge
68. Shaft
69. Interiorly Threaded Aperture
70. Catch Members
71.
72. Opening
73.
74.
75.
76.
77.
78.
79.
80. Leverage Member
81.
82. Engaging Edge

I claim:

1. A cabinet door system, comprising:
an outer frame having a front surface, a rear surface, and a center opening;
a retaining structure pivotally attached to said rear surface of said outer frame;
an inner panel removably positioned between said retaining structure and said outer frame enclosing said center opening; and
at least one latch for removably securing said retaining structure adjacent said outer frame, wherein said at least one latch includes a shaft slidably positioned within that is extendible to catchably engage said retaining structure.

2. The cabinet door system of claim 1, wherein said outer frame includes an inner rabbet adjacent said center opening, wherein said inner rabbet is formed for receiving said retaining structure.

3. The cabinet door system of claim 2, wherein said retaining structure has an inner lip for engaging said inner panel.

4. The cabinet door system of claim 3, including a length of engaging strip attached to said inner lip.

5. The cabinet door system of claim 1, wherein a distal end of said shaft has a slanted edge.

6. The cabinet door system of claim 5, wherein said at least one latch includes a spring for pushing said shaft outwardly from said at least one latch.

7. The cabinet door system of claim 6, including at least one catch member having an opening for receiving said shaft, wherein said at least one catch member is attached to said retaining structure.

8. The cabinet door system of claim 1, wherein said center opening and said inner panel are rectangular shaped.

9. The cabinet door system of claim 4, wherein said engaging strip is comprised of a pile material.

10. The cabinet door system of claim 1, wherein said retaining structure is pivotally attached to said outer frame with at least one hinge.

11. A cabinet door system, comprising:
an outer frame having a front surface, a rear surface, and a center opening;
a retaining structure pivotally attached to said rear surface of said outer frame;
an inner panel removably positioned between said retaining structure and said outer frame enclosing said center opening; and
at least one latch for removably securing said retaining structure adjacent said outer frame, wherein said at least one latch includes a shaft slidably positioned within that is extendible to catchably engage said retaining structure, a lip extending from a body of said at least one latch, and a leverage member rotatably attached to said shaft having an engaging end for engaging said lip.

12. The cabinet door system of claim 11, wherein said outer frame includes an inner rabbet adjacent said center opening, wherein said inner rabbet is formed for receiving said retaining structure.

13. The cabinet door system of claim 12, wherein said retaining structure has an inner lip for engaging said inner panel.

14. The cabinet door system of claim 13, including a length of engaging strip attached to said inner lip.

15. The cabinet door system of claim 11, wherein a distal end of said shaft has a slanted edge.

16. The cabinet door system of claim 15, wherein said at least one latch includes a spring for pushing said shaft outwardly from said at least one latch.

17. The cabinet door system of claim 16, including at least one catch member having an opening for receiving said shaft, wherein said at least one catch member is attached to said retaining structure.

18. The cabinet door system of claim 11, wherein said center opening and said inner panel are rectangular shaped.

19. The cabinet door system of claim 14, wherein said engaging strip is comprised of a pile material.

20. The cabinet door system of claim 11, wherein said retaining structure is pivotally attached to said outer frame with at least one hinge.
